(19) United States
(12) Patent Application Publication
(10) Pub. No.: US 2026/0181324 A1
(43) Pub. Date: Jun. 25, 2026

(54) CONNECTION METHODS FOR AUDIO PLAYBACK APPARATUS GROUP AND AUDIO PLAYBACK APPARATUSES THEREOF

(71) Applicant: Samsung Electronics Co., Ltd., Suwon-si (KR)

(72) Inventors: Taotao DONG, Xi'an (CN); Kun WANG, Xi'an (CN); Ying HUANG, Xi'an (CN); Xulong DU, Xi'an (CN); Qianchuang LI, Xi'an (CN)

(73) Assignee: Samsung Electronics Co., Ltd., Suwon-si (KR)

(21) Appl. No.: 19/020,292

(22) Filed: Jan. 14, 2025

(30) Foreign Application Priority Data
Dec. 24, 2024 (CN) 202411924026.5

(51) Int. Cl. H04R 3/12

(52) U.S. Cl. CPC H04R 3/12; H04R 2420/07

(57) ABSTRACT

A connection method for an audio playback apparatus group, the audio playback apparatus group including a first audio playback apparatus and a second audio playback apparatus each sharing a first address and a second address, and the connection method including establishing a first connection between the first audio playback apparatus and the second audio playback apparatus using the first address, the first connection being based on a first Bluetooth mode, establishing, by the first audio playback apparatus, a second connection and a third connection with a first audio source device using the second address, the second connection being based on the first Bluetooth mode, and the third connection being based on a second Bluetooth mode, and establishing, by the second audio playback apparatus, a fourth connection with the first audio source device using the first address, the fourth connection being based on first Bluetooth mode.

### CROSS-REFERENCE TO RELATED APPLICATIONS

This application claims priority under 35 U.S.C. § 119 to Chinese Patent Application No. 202411924026.5, filed on Dec. 24, 2024 the entire contents of which are incorporated herein by reference.

### TECHNICAL FIELD

Example embodiments of the present inventive concepts relate to the technical field of Bluetooth, and more particularly, relate to connection methods for an audio playback apparatus group and audio playback apparatuses thereof.

### BACKGROUND

The existing True Wireless Stereo (TWS) buds solution has undergone many rounds of technical iterations, and there are currently two mainstream schemes.

One is a Snooping/Mirroring scheme based on Classic Audio, as shown in FIG. 1A, which mainly includes the following elements: a primary bud establishes a classic Bluetooth connection with an audio source device (ASD), and uses an asynchronous connection-oriented link (ACL) connection based on basic rate/enhanced data rate (BR/EDR) technology to transmit data (marked as BR/EDR-ACL in the figure); the primary bud and a secondary bud establishes intra link through the classic Bluetooth connection; the primary bud synchronizes connection information between the primary bud and the ASD to the secondary bud through the connection between the primary and secondary buds (e.g., the intra link); the secondary bud uses the connection information synchronized by the primary bud to snoop audio data between the ASD and the primary bud, and ensures (or increases the likelihood that) that the audio data is received correctly on both the primary and secondary buds through acknowledgment (ACK) and negative acknowledgment (NACK) mechanisms.

The other scheme is a low energy audio (LE Audio) scheme recently launched by the Bluetooth Alliance, which addresses a challenge of multichannel audio synchronization in a standard form and supports advertising. The scheme is as illustrated in FIG. 1B, in which left and right buds both establish connection with the ASD, and use the LE-based ACL connection (marked as LE-ACL in the figure) and a connected isochronous stream (CIS) connection to transmit data, wherein the ACL connection is used for conventional data transmission, while the CIS connection is used for isochronous data (typically audio data from left and right earbuds), and the CIS connection has lower power consumption and thus is suitable for scenarios where power consumption requirements (or standards) are strict. The LE Audio has obvious standard advantages over classic Bluetooth in terms of multi-channel synchronization, and supports new application scenarios such as advertising, audio sharing, etc. However, for user scenarios such as high-definition audio, voice assistants, active noise reduction, vocal enhancement, and the like, that have maturely supported classic Bluetooth, the LE Audio is still evolving.

At present, most ASDs on the market only support Classic Audio. In order to smooth the transition of the user experience and improve the compatibility of buds with the ASDs, a dual-mode audio solution (that is, a scheme that supports both Classic Audio and LE Audio) is actively promoted by many leading manufacturers. However, in the existing dual-mode audio solution, in order to distinguish between primary and secondary buds, the primary and secondary buds often use different public addresses, the ASD establishes a classic Bluetooth connection and a low energy Bluetooth (BLE) connection with the primary bud, and the secondary bud obtains audio data relying on the connection between the primary bud and the ASD. Although this kind of scheme may achieve compatibility with the Classic Audio and the LE Audio, when the roles of the primary and secondary buds are switched (for example, the cases where the primary bud is low in battery, the primary bud is not in-ear, etc.), the addresses of the two buds are exchanged, and classic Bluetooth connection information, classic Bluetooth Profile information, BLE connection information, GATT (Generic Attribute Profile) Context and LE Audio-related Profile status, etc. of the original primary bud are synchronized to the original secondary bud (that is, the new primary bud). This scheme has a disadvantage of increasing difficulty in software design and implementation.

### SUMMARY

Example embodiments provide for reduced difficulty in software design and implementation of dual-mode TWS buds.

According to example embodiments of the present inventive concepts, there is provided a connection method for an audio playback apparatus group, the audio playback apparatus group including a first audio playback apparatus and a second audio playback apparatus, the first audio playback apparatus and the second audio playback apparatus each sharing a first address and a second address, and the connection method including establishing a first connection between the first audio playback apparatus and the second audio playback apparatus using the first address, the first connection being based on a first Bluetooth mode, establishing, by the first audio playback apparatus, a second connection and a third connection with a first audio source device using the second address, the second connection being based on the first Bluetooth mode, and the third connection being based on a second Bluetooth mode, and establishing, by the second audio playback apparatus, a fourth connection with the first audio source device using the first address, the fourth connection being based on first Bluetooth mode.

In addition, the establishing the second connection and the third connection includes setting, by the first audio playback apparatus, a connection status in the first Bluetooth mode to a discoverable and connectable status, and setting, by the first audio playback apparatus, a connection status in the second Bluetooth mode to a discoverable and connectable status.

In addition, the establishing the fourth connection includes setting, by the second audio playback apparatus, a connection status in the first Bluetooth mode to an undiscoverable and connectable status.

In addition, the connection method further includes disconnecting, by the first audio playback apparatus, the third connection in response to the first audio playback apparatus being switched from a primary apparatus to a secondary apparatus, and establishing, by the second audio playback apparatus, a fifth connection with the first audio source device using the second address in response to the second audio playback apparatus being switched from the secondary apparatus to the primary apparatus, and the fifth connection being based on the second Bluetooth mode.

In addition, the connection method further includes establishing, by a primary apparatus, a sixth connection and a seventh connection with a second audio source device using the second address in response to determining a presence of the second audio source device, the primary apparatus being a first apparatus among the first audio playback apparatus and the second audio playback apparatus, the sixth connection being based on the first Bluetooth mode, and the seventh connection being based on the second Bluetooth mode, and establishing, by a secondary apparatus, an eighth connection with the second audio source device using the first address in response to determining the presence of the second audio source device, the secondary apparatus being a second apparatus among the first audio playback apparatus and the second audio playback apparatus, the second apparatus being different from the first apparatus, and the eighth connection being based on the first Bluetooth mode.

In addition, the first Bluetooth mode is a BLE mode and the second Bluetooth mode is a classic Bluetooth mode, or the first address is a static random address and the second address is a public address.

According to example embodiments of the present inventive concepts, there is provided a connection method for a first audio playback apparatus in an audio playback apparatus group, the audio playback apparatus group including a second audio playback apparatus, the first audio playback apparatus and the second audio playback apparatus each sharing a first address and a second address, and the connection method including establishing a first connection with the second audio playback apparatus using the first address, the first connection being based on a first Bluetooth mode, and establishing a second connection and a third connection with a first audio source device using the second address, the second connection being based on the first Bluetooth mode, the third connection being based on a second Bluetooth mode, and a fourth connection being established between the second audio playback apparatus and the first audio source device using the first address, the fourth connection being based on the first Bluetooth mode.

In addition, the establishing the second connection and the third connection includes setting a connection status in the first Bluetooth mode to a discoverable and connectable status, and setting a connection status in the second Bluetooth mode to a discoverable and connectable status.

In addition, the connection method further includes disconnecting the third connection in response to the first audio playback apparatus being switched from a primary apparatus to a secondary apparatus, a fifth connection being established between the second audio playback apparatus and the first audio source device using the second address in response to the second audio playback apparatus being switched from the secondary apparatus to the primary apparatus, and the fifth connection being based on the second Bluetooth mode.

In addition, the connection method further includes establishing a sixth connection and a seventh connection with a second audio source device using the second address in response to determining a presence of the second audio source device and based on the first audio playback apparatus being a primary apparatus, the sixth connection being based on the first Bluetooth mode, and the seventh connection being based on the second Bluetooth mode, or establishing an eighth connection with the second audio source device using the first address in response to determining the presence of the second audio source device and based on the first audio playback apparatus being a secondary apparatus, the eighth connection being based on the first Bluetooth mode.

In addition, the first Bluetooth mode is a BLE mode, and the second Bluetooth mode is a classic Bluetooth mode, or the first address is a static random address, and the second address is a public address.

According to example embodiments of the present inventive concepts, there is provided a connection method for a second audio playback apparatus in an audio playback apparatus group, the audio playback apparatus group including a first audio playback apparatus, the first audio playback apparatus and the second audio playback apparatus each sharing a first address and a second address, and the connection method including establishing a first connection with the first audio playback apparatus using the first address, the first connection being based on a first Bluetooth mode, and establishing a second connection with a first audio source device using the first address, the second connection being based on the first Bluetooth mode, a third connection and a fourth connection being established between the first audio playback apparatus and the first audio source device using the second address, the third connection being based on the first Bluetooth mode, and the fourth connection being based on a second Bluetooth mode.

In addition, the establishing the second connection includes setting a connection status in the first Bluetooth mode to an undiscoverable and connectable status.

In addition, the connection method further includes establishing a fifth connection with the first audio source device using the second address in response to the second audio playback apparatus being switched to a primary apparatus from a secondary apparatus, the fifth connection being based on the second Bluetooth mode, the fourth connection being disconnected based on the first audio playback apparatus being switched to the secondary apparatus from the primary apparatus.

In addition, the connection method further includes establishing a sixth connection and a seventh connection with a second audio source device using the second address in response to determining a presence of the second audio source device and based on the second audio playback apparatus being a primary apparatus, the sixth connection being based on the first Bluetooth mode, and the seventh connection being based on the second Bluetooth mode, or establishing an eighth connection with the second audio source device using the first address in response to determining the presence of the second audio source device and based on the second audio playback apparatus being a secondary apparatus, the eighth connection being based on the first Bluetooth mode.

In addition, the first Bluetooth mode is a BLE mode and the second Bluetooth mode is a classic Bluetooth mode, or the first address is a static random address and the second address is a public address.

According to example embodiments of the present inventive concepts, there is provided a first audio playback apparatus in an audio playback apparatus group, the audio playback apparatus group including a second audio playback apparatus, the first audio playback apparatus and the second audio playback apparatus each sharing a first address and a second address, and the first audio playback apparatus including processing circuitry configured to establish a first connection with the second audio playback apparatus using the first address, the first connection being based on a first Bluetooth mode, and establish a second connection and a third connection with a first audio source device using the second address, the second connection being based on the first Bluetooth mode, the third connection being based on a second Bluetooth mode, a fourth connection being established between the second audio playback apparatus and the first audio source device using the first address, the fourth connection being based on the first Bluetooth mode.

In addition, the processing circuitry is configured to set a connection status in the first Bluetooth mode to a discoverable and connectable status, and set a connection status in the second Bluetooth mode to a discoverable and connectable status.

In addition, the processing circuitry is configured to disconnect the third connection in response to the first audio playback apparatus being switched from a primary apparatus to a secondary apparatus, a fifth connection being established between the second audio playback apparatus and the first audio source device using the second address in response to the second audio playback apparatus being switched from the secondary apparatus to the primary apparatus, and the fifth connection being based on the second Bluetooth mode.

In addition, the processing circuitry is configured to establish a sixth connection and a seventh connection with a second audio source device using the second address in response to determining a presence of the second audio source device and based on the first audio playback apparatus being a primary apparatus, the sixth connection being based on the first Bluetooth mode, and the seventh connection being based on the second Bluetooth mode, or establish an eighth connection with the second audio source device using the first address in response to determining the presence of the second audio source device and based on the first audio playback apparatus being a secondary apparatus, the eighth connection being based on the first Bluetooth mode.

In addition, the first Bluetooth mode is a BLE mode and the second Bluetooth mode is a classic Bluetooth mode, or the first address is a static random address and the second address is a public address.

According to example embodiments of the present inventive concepts, there is provided a second audio playback apparatus in an audio playback apparatus group, the audio playback apparatus group including a first audio playback apparatus, the first audio playback apparatus and the second audio playback apparatus each sharing a first address and a second address, the second audio playback apparatus including processing circuitry configured to establish a first connection with the first audio playback apparatus using the first address, the first connection being based on a first Bluetooth mode, and establish a second connection with a first audio source device using the first address, the second connection being based on the first Bluetooth mode, a third connection and a fourth connection being established between the first audio playback apparatus and the first audio source device using the second address, the third connection being based on the first Bluetooth mode, and the fourth connection being based on a second Bluetooth mode.

In addition, the processing circuitry is configured to set a connection status in the first Bluetooth mode to an undiscoverable and connectable status.

In addition, the processing circuitry is configured to establish a fifth connection with the first audio source device using the second address in response to the second audio playback apparatus being switched to a primary apparatus from a secondary apparatus, the fifth connection being based on the second Bluetooth mode, the fourth connection being disconnected based on the first audio playback apparatus being switched to the secondary apparatus from the primary apparatus.

In addition, the processing circuitry is configured to establish a sixth connection and a seventh connection with a second audio source device using the second address in response to determining a presence of the second audio source device and based on the second audio playback apparatus being a primary apparatus, the sixth connection being based on the first Bluetooth mode, and the seventh connection being based on the second Bluetooth mode, or establish an eighth connection with the second audio source device using the first address in response to determining the presence of the second audio source device and based on the second audio playback apparatus being a secondary apparatus, the eighth connection being based on the first Bluetooth mode.

In addition, the first Bluetooth mode is a BLE mode and the second Bluetooth mode is a classic Bluetooth mode, or the first address is a static random address and the second address is a public address.

According to example embodiments of the present inventive concepts, there is provided an audio playback apparatus group, wherein the audio playback apparatus group includes a first audio playback apparatus and a second audio playback apparatus.

According to example embodiments of the present inventive concepts, there is provided a non-transitory computer-readable medium having stored thereon computer executable instructions that, when executed by processing circuitry, cause the processing circuitry to execute one or more of the aforementioned methods.

According to example embodiments of the present inventive concepts, there is provided a non-transitory computer program product including computer executable instructions that, when executed by processing circuitry, cause the processing circuitry to execute one or more of the aforementioned methods.

According to example embodiments of the present inventive concepts, by configuring a first address and a second address to a first audio playback apparatus and a second audio playback apparatus of an audio playback apparatus group at the same time (or contemporaneously), on the one hand, it is possible to make the two audio playback apparatuses use different addresses to establish the Bluetooth connections with the first audio source device, that is, the first audio playback apparatus uses the second address and the second audio playback apparatus uses the first address, so that reliable establishment of the Bluetooth connections may be ensured (or the likelihood thereof improved). On the other hand, the operations related to primary-secondary role switching between the two audio playback apparatuses can be simplified. Specifically, from the perspective of information synchronization, since both audio playback apparatuses have established a connection in the first Bluetooth mode with the first audio source device respectively, after the role switching, the original connections in the first Bluetooth mode may be continuously used without being affected, so that the two audio playback apparatuses only need to (or should) synchronize the connection information related to the second Bluetooth mode, without needing to synchronize the connection information related to the first Bluetooth mode (or decreasing the likelihood thereof), which can simplify information synchronization and reduce related computational complexity. From the perspective of address exchange, since both audio playback apparatuses share the same first address, when transferring the connection in the second Bluetooth mode with the first audio source device from the first audio playback apparatus to the second audio playback apparatus, the second audio playback apparatus can directly use its own first address without performing address exchange operation. Therefore, when primary-secondary role switching occurs between the two audio playback apparatuses, no address exchange, complex information synchronization, and corresponding configuration is required (or implemented). Besides, from the perspective of the first audio source device, its connection information with the first audio playback apparatus in the first Bluetooth mode has been synchronized to the second audio playback apparatus, while the connection itself in the first Bluetooth mode has not changed, and its connections with the two audio playback apparatuses in the second Bluetooth mode have not changed either. Therefore, the connection between the first audio source device and the audio playback apparatus group may be unchanged, thereby significantly reducing the difficulty of the software design and implementation. In addition, since both of the audio playback apparatuses establish the connections in the first Bluetooth mode with the first audio source device, tolerance of the audio playback apparatus group to connection congestion or abnormality may be improved, and robustness of the audio playback apparatus group may be improved.

Other aspects and/or advantages of the general concept of the present disclosure will be partially illustrated in the subsequent depictions, and the other parts will become clear through the depiction or may be learned through the implementation of the general concept of the present disclosure.

### BRIEF DESCRIPTION OF THE DRAWINGS

The above and other purposes and features of example embodiments of the present inventive concepts will become more apparent from the following detailed descriptions, taken in conjunction with the accompanying drawings illustrating one or more examples, in which:

FIG. 1A is a topology diagram illustrating a true wireless stereo scheme based on Classic Audio of related art;

FIG. 1B is a topology diagram illustrating a true wireless stereo scheme based on LE Audio of related art;

FIG. 2 is a topology diagram illustrating a dual-mode audio solution of related art;

FIG. 3 is a flowchart diagram illustrating a connection method for an audio playback apparatus group according to example embodiments of the present inventive concepts;

FIG. 4 is a schematic diagram illustrating modules of an audio playback apparatus group according to example embodiments of the present inventive concepts;

FIG. 5 is a schematic diagram illustrating connection elements of an audio playback apparatus group according to example embodiments of the present inventive concepts;

FIG. 6 is a topology diagram illustrating a single point topology of an audio playback apparatus group before and after role switching according to example embodiments of the present inventive concepts;

FIG. 7 is a topology diagram illustrating a multi-point topology of an audio playback apparatus group in the case where no role switching occurs according to example embodiments of the present inventive concepts;

FIG. 8 is a topology diagram illustrating a multi-point topology of an audio playback apparatus group in the case where role switching occurs according to example embodiments of the present inventive concepts;

FIG. 9 is a flowchart diagram illustrating a connection method for a first audio playback apparatus as a primary apparatus according to example embodiments of the present inventive concepts;

FIG. 10 is a flowchart diagram illustrating a connection method for a second audio playback apparatus as a secondary apparatus according to example embodiments of the present inventive concepts;

FIG. 11 is a block diagram illustrating a first audio playback apparatus as a primary apparatus according to example embodiments of the present inventive concepts; and

FIG. 12 is a block diagram illustrating a second audio playback apparatus as a secondary apparatus according to example embodiments of the present inventive concepts.

### DETAILED DESCRIPTION

Hereinafter, example embodiments of the present inventive concepts are described with reference to the accompanying drawings, in which the same reference numerals are used to depict the same or similar elements, features, and structures. However, the present inventive concepts are not intended to be limited by example embodiments described herein and it is intended that example embodiments of the present inventive concepts cover all modifications, equivalents, and/or alternatives of example embodiments described herein, provided they come within the scope of the appended claims and their equivalents. The terms and words used in the following description and claims are not limited to their dictionary meanings, but, are merely used to enable a clear and consistent understanding of example embodiments of the present inventive concepts. Accordingly, it should be apparent to those ordinarily skilled in the art that the following descriptions of example embodiments of the present inventive concepts are provided for illustration purposes only and not for the purpose of limiting example embodiments of the present inventive concepts as defined by the appended claims and their equivalents.

It is to be understood that the singular forms include plural forms, unless the context clearly indicates otherwise. The terms “include”, “contain”, and “have”, used herein, indicate functions, operations, or the existence of elements of the disclosure, but do not exclude other functions, operations, or elements.

For example, the expression “A or B”, or “at least one of A and/or B” may indicate A and B, and A or B. For example, the expression “A or B” or “at least one of A and/or B” may indicate (1) A, (2) B, or (3) both A and B.

In example embodiments of the present inventive concepts, it is intended that when a component (for example, a first component) is referred to as being “coupled” or “connected” with/to another component (for example, a second component), the component may be directly connected to the another component or may be connected through another component (for example, a third component). In contrast, when a component (for example, a first component) is referred to as being “directly coupled” or “directly connected” with/to another component (for example, a second component), another component (for example, a third component) does not exist between the component and the other component (e.g., between the first and second component).

The expression “configured to”, used in describing example embodiments of the present inventive concepts, may be used interchangeably with expressions “suitable for”, “having the capacity to . . . ”, “designed to”, “adapted to”, “made to”, and “capable of”, for example, according to the situation. The term “configured to” may not necessarily indicate “specifically designed to” in terms of hardware. Instead, the expression “a device configured to . . . ” in some situations may indicate that the device and another device or part are “capable of . . . ”. For example, the expression “a processor configured to perform A, B, and C” may indicate a dedicated processor (for example, an embedded processor) for performing a corresponding operation or a general purpose processor (for example, a central processing unit (CPU) or an application processor (AP)) for performing corresponding operations by executing at least one software program stored in a memory device.

The terms used herein are to describe certain examples of the present disclosure, but are not intended to limit the scope of other examples. Unless otherwise indicated herein, all terms used herein, including technical or scientific terms, may have the same meanings as (or a similar meaning to) those generally understood by a person ordinarily skilled in the art. In general, terms defined in a dictionary should be considered to have the same meanings as (or similar meanings to) the contextual meanings in the related art, and, unless clearly defined herein, should not be understood differently or as having an excessively formal meaning. In any case, even terms defined in examples of the present inventive concepts are not intended to be interpreted as excluding other examples of the present inventive concepts.

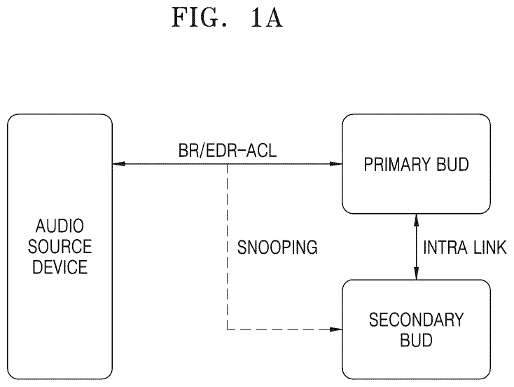

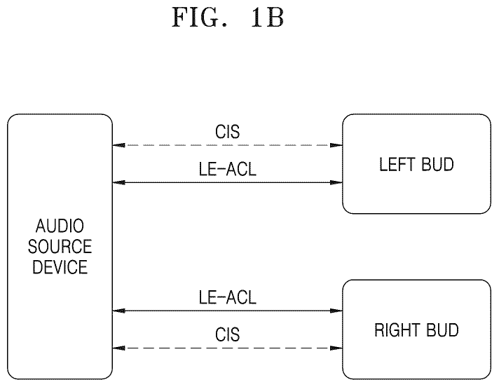

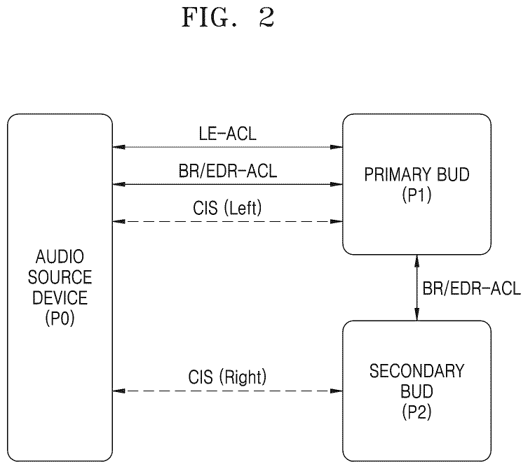

Currently, there exists a dual-mode audio solution called Split CIG (Split Connected Isochronous Group), whose low energy Bluetooth (BLE) mode emulates the split form in the classic Bluetooth mode. In this scheme, primary and secondary buds have different public addresses, respectively. The public address is assigned by the Institute of Electrical and Electronics Engineers (IEEE) and is a unique and unchanging address of a Bluetooth device. In a classic Bluetooth mode, a public address is used to establish a connection. FIG. 2 shows the topology diagram of this Split CIG scheme. According to example embodiments, classic Bluetooth mode may refer to Bluetooth communication using an ACL connection based on BR/EDR technology to transmit data, as discussed in connection with FIG. 1A, and BR/EDR-ACL is used to represent the classic Bluetooth connection in FIG. 2, but example embodiments are not limited thereto. As shown in FIG. 2, the public address of the primary bud is represented as P1, and the public address of the secondary bud is represented as P2. A classic Bluetooth connection BR/EDR-ACL (P1<->P2) is established between the primary and secondary buds, and the classic Bluetooth connection BR/EDR-ACL (P0<->P1) and a low energy Bluetooth (BLE) connection LE-ACL (P0<->P1) are established between an audio source device and the primary bud. After the Bluetooth connection is established, the audio source device and the primary bud determine access addresses according to their own public addresses, respectively, so that the audio source device and the bud then transmit data based on the access addresses.

Over the transmission of data, in the classic Bluetooth mode, the secondary bud snoops the audio data between the primary bud and the audio source device. In the BLE mode, the secondary bud does not use CIS characteristics of an LE Audio standard to perform audio transmission and reception, but instead emulate the split form in the classic Bluetooth mode, where the primary bud is responsible for the main data transmission and control tasks, and splits some data to the secondary bud. Specifically, the primary bud advertises two different Published Audio Capabilities (PACs) through the primary bud to inform the audio source device that the primary bud supports a left channel and a right channel. When there is an audio service, the audio source device will establish a Connected Isochronous Group (CIG) based on the received PAC information. The CIG includes a CIS (Left) carrying left-channel audio data and a CIS (Right) carrying right-channel audio data. Both CISes depend on the BLE connection LE-ACL (P0<->P1) between the audio source device and the primary bud. The primary bud synchronizes connection information of one of the CISes to the secondary bud through the classic Bluetooth connection BR/EDR-ACL (P1<->P2) between the primary and secondary buds. The connection information includes the aforementioned access address, connection key, etc. For example, as shown in FIG. 2, in the case where the left bud serves as the primary bud and the right bud serves as the secondary bud, the primary bud synchronizes the connection information of CIS (Right) carrying the right-channel audio data to the secondary bud, and vice versa. After receiving the CIS connection information synchronized by the primary bud, the secondary bud uses the CIS connection information to fully serve the CIS with its public address P2, including directly receiving data, directly replying to ACK, or directly transmitting microphone data, but not performing other control tasks.

After the roles of the primary and secondary buds are switched, the original primary bud needs to synchronize the classic Bluetooth connection information and profile information with the new primary bud, so that the new primary bud can maintain the classic Bluetooth connection BR/EDR-ACL (P0<->P1) with the audio source device. This is an existing operation of the classic Bluetooth mode. Due to the fact that this scheme dose not use CIS characteristics of the LE Audio standard, but instead emulate the split form in the classic Bluetooth mode, the BLE connection information, GATT Context and LE Audio-related Profile status need to (or should) be additionally synchronized, to ensure that the new primary bud can maintain the BLE connection LE-ACL (P0<->P1) with the audio source device (or increase the likelihood thereof). At the same time, due to the need to continue using the previously determined access address to achieve data transmission, and the fact that it is the public address P1 of the original primary bud that matches with the access address, the two buds also need to (or should) exchange their public addresses, so that the new primary bud obtains the public address P1 of the original primary bud. And corresponding configurations need to (or should) be made to instruct the primary bud to perform the above address exchange operation when a primary-secondary role switching occurs. These complex information synchronization, address exchange and corresponding configurations make this scheme have a disadvantage of increasing the difficulty of software design and implementation.

Besides, after completing information synchronization, the new primary bud also needs to (or should) recalculate the CIS anchor point (referring to the time point when the first CIS data packet is sent in the BLE connection event) and CIS information bias (referring to the time offset from the ACL anchor point of the connection event counter to the first CIS anchor point), which will also bring additional computational complexity. And there is only one BLE connection LE-ACL (P0<->P1) established between the audio source device and the buds. Once this BLE connection becomes congested or abnormal, it will affect the two CIS connections, resulting in low robustness.

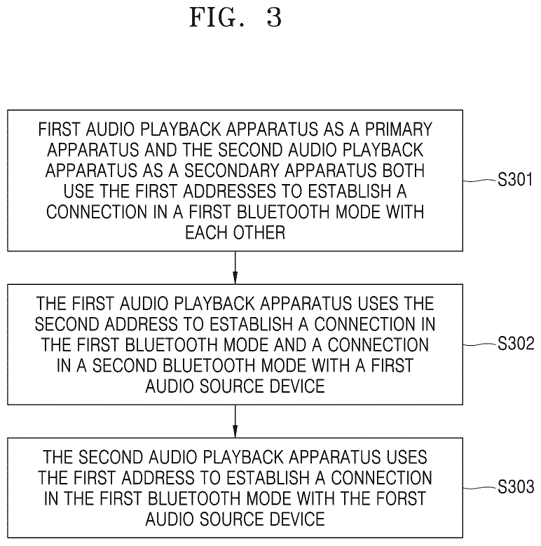

FIG. 3 is a flowchart diagram illustrating a connection method for an audio playback apparatus group according to example embodiments of the present inventive concepts. According to example embodiments, the audio playback apparatus group includes a first audio playback apparatus (e.g., a first bud, a first hearing aid, a first speaker, a first smart device, etc.) and a second audio playback apparatus (e.g., a second bud, a second hearing aid, a second speaker, a second smart device, etc.), and the first audio playback apparatus and the second audio playback apparatus each have (e.g., share) a first address and a second address.

Referring to FIG. 3, in operation S301, the first audio playback apparatus as a primary apparatus and the second audio playback apparatus as a secondary apparatus both use the first address to establish a connection in a first Bluetooth mode with each other.

This operation ensures (or increases the likelihood) that information may be easily transferred between the two audio playback apparatuses.

According to example embodiments, regarding the difference between the primary and secondary apparatuses, the primary apparatus is responsible for establishing a connection and pairing with the audio source device, receiving audio signals from the audio source device, and forwarding them to the secondary apparatus. In addition, the primary apparatus usually undertakes more control tasks, such as volume control, answering calls, activating voice assistants, power management (e.g., issuing reminders when low battery), etc. The secondary apparatus is usually responsible for receiving audio signals from the primary apparatus and playing them to achieve stereo sound. In some cases, the secondary apparatus can also perform some control tasks, such as touch control, but these functions are usually managed by the primary apparatus. However, example embodiments are not limited thereto.

In operation S302, the first audio playback apparatus uses the second address to establish a connection in the first Bluetooth mode and a connection in a second Bluetooth mode with a first audio source device.

The primary apparatus may realize the connection in two different Bluetooth modes, so that the audio playback apparatus group may support different Bluetooth modes, thereby ensuring the compatibility of the audio playback apparatus group with the audio source devices (or improving the likelihood thereof). It should be understood that what the present disclosure provides is an ability to establish the connection in different Bluetooth modes with the audio source device. The audio playback apparatus group may, or may not, establish the connection in two Bluetooth modes with the first audio source device at the same time (or contemporaneously). Whichever Bluetooth mode the first audio source device supports, the audio playback apparatus group may establish a connection in the corresponding Bluetooth mode with the first audio source device.

As an example, the first Bluetooth mode is a BLE mode, and the second Bluetooth mode is a classic Bluetooth mode so as to be compatible with two mainstream Bluetooth modes in the current industry. The second address is a public address capable of supporting establishment of the classic Bluetooth mode connection. The first address may be a random address, such as a Static Random Address, a Private Random Address, which may be randomly (or pseudo-randomly) generated after an apparatus starts, to satisfy additional requirements (or standards) in the BLE mode. Specifically, on the one hand, the number of the BLE apparatuses far exceeds the number of the classic Bluetooth apparatuses, and application and management of the public addresses are relatively cumbersome, resulting in increased costs for address purchase and maintenance. Random addresses may help to reduce costs; on the other hand, a large part of the application scenarios of the BLE mode is advertising communication, which means that as long as an address of an apparatus is known, all information may be acquired. There are security risks. By using non-fixed random addresses, the risk of information leakage may be reduced and security may be improved. It should be understood that in the present disclosure, the first audio playback apparatus and the second audio playback apparatus each have a first address and a second address, so that they may share a fixed public address and a non-fixed random address, so that there is no need to perform address exchange during role switching. At this time, although the random address may change, the first addresses configured by the first audio playback apparatus and the second audio playback apparatus remain the same (or similar) after each change. According to example embodiments, references to “first addresses” herein may refer to the first address shared by both the first and second audio playback apparatuses.

According to example embodiments, the operation S302 includes: the first audio playback apparatus setting a connection status in the first Bluetooth mode to a discoverable and connectable status to use the second address to establish the connection in the first Bluetooth mode with the first audio source device; and the first audio playback apparatus setting a connection status in the second Bluetooth mode to a discoverable and connectable status to use the second address to establish the connection in the second Bluetooth mode with the first audio source device. Specifically, when the first Bluetooth mode is the BLE mode, the first audio playback apparatus uses the second address to transmit discoverable and connectable advertisement (specifically takes the second address as its identifiable address to transmit the advertisement) so as to establish the connection in the first Bluetooth mode with the first audio source device. By enabling the first audio playback apparatus as the primary apparatus to set the discoverable and connectable status in both Bluetooth modes, the first audio source device may be enabled to discover the primary apparatus and establish the connection in the second Bluetooth mode and the connection in the first Bluetooth mode with it, ensuring the reliable device connection in both Bluetooth modes (or improving the likelihood thereof).

In the operation S303, the second audio playback apparatus uses the first address to establish a connection in the first Bluetooth mode with the first audio source device.

The secondary apparatus uses the second address that is not used by the primary apparatus to establish the Bluetooth connection with the first audio source device, thereby being able to be distinguished from the primary apparatus. Specifically, the secondary apparatus only establishes the connection in the first Bluetooth mode with the first audio source device without establishing the connection in the second Bluetooth mode, may acquire connection information synchronized by the primary apparatus based on the Bluetooth connection established between the primary and secondary apparatuses, and further implements the acquisition of audio source data by snooping data transmitted between the primary apparatus and the first audio source device under the connection in the second Bluetooth mode. Based on this, when the role switching occurs between the first audio playback apparatus and the second audio playback apparatus, the connection in the first Bluetooth mode between the second audio playback apparatus and the first audio source apparatus may be continuously used without any influence, and the two audio playback apparatuses share the first address and the second address, so that no address exchange and no complex information synchronization in the first Bluetooth mode are required (or implemented) between the two audio playback apparatuses, and the connection between the first audio source device and the audio playback apparatus group does not need to change either, thereby significantly reducing the difficulty of the software design and implementation.

According to example embodiments, the operation S303 includes: the second audio playback apparatus setting a connection status in the first Bluetooth mode to an undiscoverable and connectable status to use the first address to establish the connection in the first Bluetooth mode with the first audio source device. Specifically, when the first Bluetooth mode is the BLE mode, the second audio playback apparatus uses the first address to transmit undiscoverable and connectable advertisement (specifically takes the first address as its identifiable address to transmit the advertisement) so as to establish the connection in the first Bluetooth mode with the first audio source device. By enabling the second secondary apparatus as the secondary apparatus to only establish the connection in the first Bluetooth mode with the first audio source device without establishing the connection in the second Bluetooth mode with the first audio source device (for example, set the connection status in the second Bluetooth mode to an undiscoverable and unconnectable status), confusion between the two audio playback apparatuses will not be caused from a perspective of the first audio source device, thereby ensuring the reliable establishment of the connection in the second Bluetooth mode (or improving the likelihood thereof). By enabling the secondary apparatus to set the undiscoverable and connectable status in the first Bluetooth mode, for example, to use the first address to transmit the undiscoverable and connectable advertisement, e.g., periodically advertise existence of itself, without responding to scan requests from other apparatuses, the secondary apparatus is enabled to establish the connection in the first Bluetooth mode with the first audio source device which knows the existence of the secondary apparatus (specifically the existence of the secondary apparatus is known through the primary apparatus) without being connected by other audio source devices, so that the primary and secondary apparatuses are enabled to establish the connection in the first Bluetooth mode with the same audio source device (or similar audio source devices), thereby ensuring the reliable establishment of the connection in the first Bluetooth mode (or improving the likelihood thereof).

According to example embodiments, the connection method for the audio playback apparatus group according to an example of the present disclosure further includes: in response to the first audio playback apparatus being switched to the secondary apparatus and the second audio playback apparatus being switched to the primary apparatus, the first audio playback apparatus disconnecting the connection in the second Bluetooth mode with the first audio source device, and the second audio playback apparatus using the second address to establish a connection in the second Bluetooth mode with the first audio source device. By transferring the connection in the second Bluetooth mode with the first audio source device from the original primary apparatus (e.g., the first audio playback apparatus) to a new primary apparatus (e.g., the second audio playback apparatus) while the role switching occurs, smooth communication between the new primary apparatus and the first audio source device may be ensured (or improved), and continuous work of the connection in the second Bluetooth mode is maintained. “Disconnect” and “establish” here are intended to emphasize the transfer of the connection relationship in the second Bluetooth mode without meaning that it is necessary to perform the operations of disconnecting and establishing the connection. For example, the first audio playback apparatus may synchronize connection information in the second Bluetooth mode with the first audio source device to the second audio playback apparatus, the second audio playback apparatus uses the connection information in the second Bluetooth mode and the second address to perform data transmission with the first audio source device, and at this time, the first audio source device has no sense of role switching and will not perceive the transfer of the connection relationship. Further, when the second Bluetooth mode is the classic Bluetooth mode, before the role switching occurs, in order to realize the snooping of the secondary apparatus, the primary apparatus synchronizes the connection information in the second Bluetooth mode between itself and the first audio source device to the second audio playback apparatus. Therefore, if the role switching occurs, the primary apparatus does not need to synchronize (or may not synchronize) the connection information to the secondary apparatus again (except in the case of a change in the connection information, the connection information may be synchronized again at this time to update the changed connection information, not to switch roles), and only informs the secondary apparatus that the secondary apparatus will serve as the new primary apparatus. The connection information in the second Bluetooth mode may represent all the information required (or used) to establish the connection in the second Bluetooth mode. Taking the second Bluetooth mode being the classic Bluetooth mode as an example, the connection information includes, for example, classic Bluetooth connection information (including an access address, a connection key, etc.) and classic Bluetooth Profile information. According to example embodiments, the first audio playback apparatus disconnects the connection in the first Bluetooth mode (e.g., BLE mode) with the first audio source device, and the second audio playback apparatus using the second address to establish a connection in the first Bluetooth mode with the first audio source device, but example embodiments are not limited thereto. According to example embodiments, each of the first audio playback apparatus and the second audio playback apparatus may include a respective metal coil and diaphragm. Each respective metal coil may be charged according to an audio signal received from the first audio source device (and/or the second audio source device) to physically move the diaphragm such that the diaphragm generates sound waves corresponding to the audio signal.

According to example embodiments, the connection method for the audio playback apparatus group according to an example of the present disclosure further includes: in response to a presence of a second audio source device, the audio playback apparatus as the primary apparatus among the first audio playback apparatus and the second audio playback apparatus using the second address to establish a connection in the first Bluetooth mode and a connection in the second Bluetooth mode with the second audio source device, and the audio playback apparatus as the secondary apparatus among the first audio playback apparatus and the second audio playback apparatus using the first address to establish a connection in the first Bluetooth mode with the second audio source device. For an audio playback apparatus group that may be connected to multiple audio source devices, regardless of the specific roles of two audio playback apparatuses, as long as during the establishing of Bluetooth connection with the second audio source device, the primary apparatus among the two audio playback apparatuses uses the second address while the secondary apparatus among them uses the first address, the consistency of the connection operations under the roles of the primary apparatus and the secondary apparatus may be guaranteed (or improved), so that the connection relationships of the audio playback apparatus group with the first audio source device and the second audio source device are independent, respectively. The specific connection manner may refer to the above examples, and will not be repeated here. It should be understood that the first audio source device represents the audio source device connected to the audio playback apparatus group earlier, and the second audio source device represents the audio source device connected to the audio playback apparatus group later. They are not fixed references to the audio source devices.

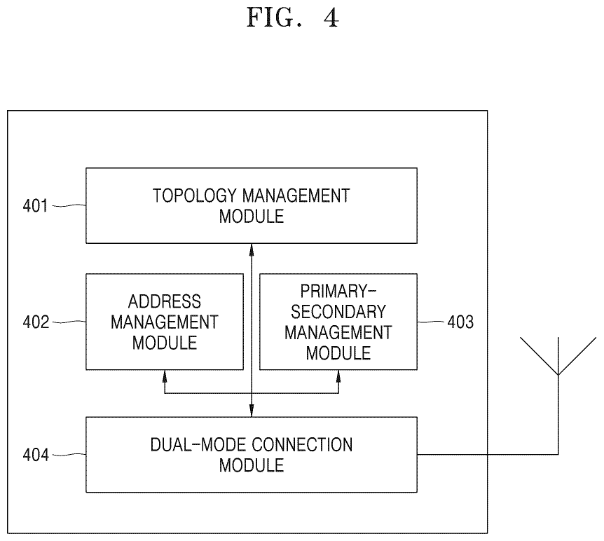

Next, an audio playback apparatus group and a connection method thereof are introduced according to example embodiments of the present disclosure with reference to FIGS. 4-8

In an example, the audio playback apparatus group is dual-mode TWS buds, including a left bud (as a first audio playback apparatus) and a right bud (as a second audio playback apparatus). A first Bluetooth mode is a BLE mode, and a second Bluetooth mode is a classic Bluetooth mode. A first address is a static random address, and a second address is a public address.

Referring to FIG. 4, the dual-mode TWS buds of the specific example are configured with a dual-mode connection module 401, an address management module 402, a primary-secondary management module 403 and/or a topology management module 404. The dual-mode connection module 401 is used to implement underlying connections in the classic Bluetooth mode and the BLE mode, and may further include a classic Bluetooth module (not shown in the figures) and a BLE module (not shown in the figures). The address management module 402 is used to manage a public address (denoted by P1 hereinafter) and a static random address (denoted by S1 hereinafter) of the two buds. The primary-secondary management module 403 is used to negotiate and manage primary and secondary roles of the two buds. For example, to default the left bud as a primary bud and the right bud as a secondary bud, or may also determine the primary and secondary roles of the two buds according to electric quantity (e.g., battery charge), in-ear status, etc. of the buds. The topology management module 404 is used to manage connections of the left and right buds with the audio source device, and a connection between the left and right buds. A basic relationship among these modules is that the address management module 402 determines that each bud uses P1 or S1 as a BLE connection identification address of the bud according to the bud role negotiated by the primary-secondary management module 403. The topology management module 404 controls the connection of the dual-mode connection module 401 with the audio source device according to the bud connection identification address.

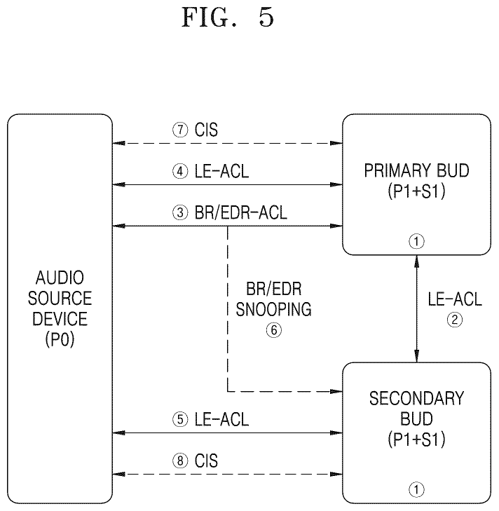

The example contains following specific elements.
1) The primary bud and the secondary bud have (e.g., share) the same public address P1 and static random address S1 (or similar public addresses P1 and similar random addresses S1), as illustrated by identifier \textcircled{1} in FIG. 5.
2) A BLE connection (represented using LE-ACL) is established between the primary and secondary buds using the static random address (S1<->S1), as illustrated by identifier \textcircled{2} in FIG. 5. The connection is established depending on advertisement in the BLE mode. To establish a connection between earbuds, one earbud sends a connectable advertisement, and the other earbud scans. The scanned earphone devices use the same identification address S (or a similar identification address S) to scan and connect. Therefore, the primary and secondary buds may also establish the connection even if they use the same address (or similar addresses).
3) A classic Bluetooth connection (represented using BR/EDR-ACL) is established between the audio source device (having a public address P0) and the primary bud (P0<->P1), as illustrated by identifier \textcircled{3} in FIG. 5, and A LE-ACL (P0<->P1) is established, as illustrated by identifier \textcircled{4} in FIG. 5.
4) A LE-ACL (P0<->S1) is established between the audio source device and the secondary bud, as illustrated by identifier \textcircled{5} in FIG. 5.
5) In the classic Bluetooth mode, the secondary bud snoops the data transmission between the primary bud and the audio source device (represented using BR/EDR Snooping), as illustrated by identifier \textcircled{6} in FIG. 5.
6) In the BLE mode, the audio source device establishes CIS based on connection with the primary bud, as illustrated by identifier \textcircled{7} in FIG. 5. The audio source device establishes CIS based on connection with the secondary bud, as illustrated by identifier \textcircled{8} in FIG. 5.

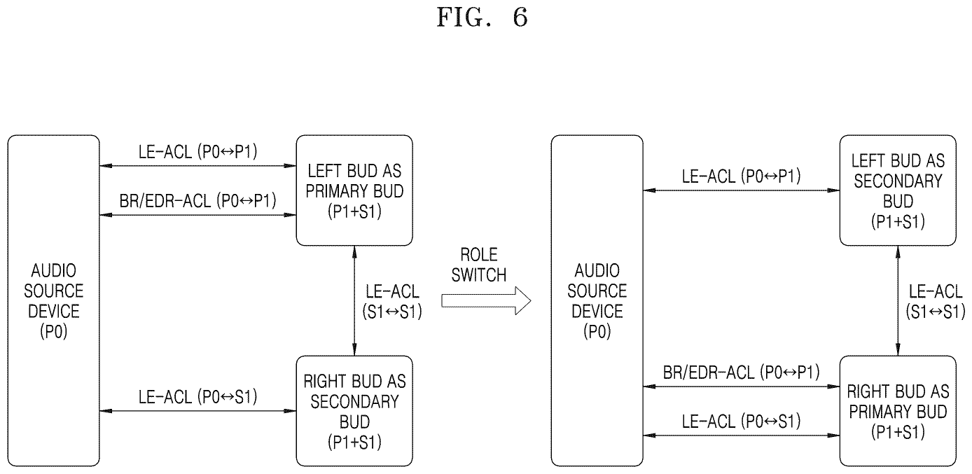

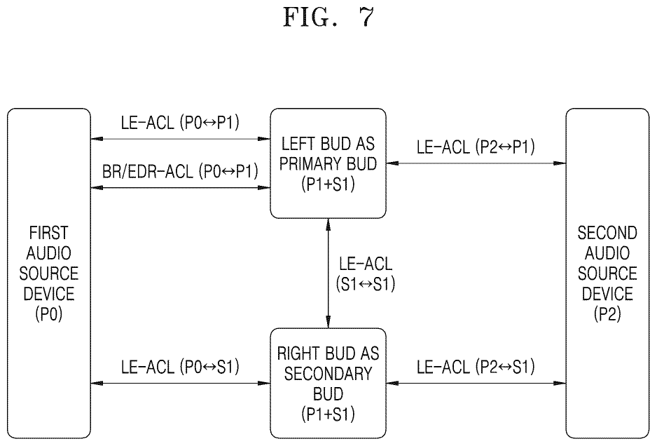

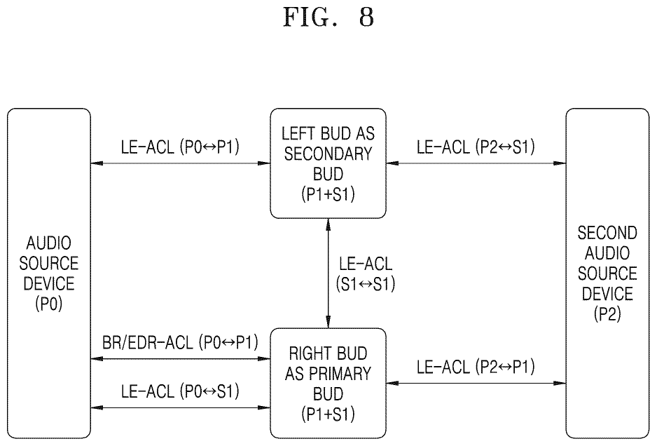

The connection processes in different scenarios are as follows (for simplified representation, the CIS connection is not drawn in FIGS. 6 to 8).
1. Single Point Topology as is illustrated in FIG. 6. At this time, the buds only support the connection with one audio source device. After a lid is opened and the buds are out of a box, the buds establish dual-mode Bluetooth connection with an audio source device.
a) The LE-ACL (S1<->S1) is established between the two buds, and primary and secondary buds are negotiated by the primary-secondary management module 403.
b) Primary bud: The classic Bluetooth module is set to a discoverable and connectable mode. A BLE module transmits discoverable and connectable advertisement using address P1 as its identifiable address.
c) Secondary bud: The classic Bluetooth module is in an undiscoverable and unconnectable status. The BLE module transmits undiscoverable and connectable advertisement using address S1 as its identifiable address.
d) The audio source device discovers the buds through scanning to perform connection pairing, establishes the LE-ACL (P0<->P1) and BR/EDR-ACL (P0<->P1) with the primary bud, and establishes the LE-ACL (P0<->S1) with the secondary bud.
e) While the role switching occurs, the primary bud synchronizes classic Bluetooth mode connection information (including LE-ACL (P0<->P1) information and classic Bluetooth Profile information) to the secondary bud. There is no change in the LE-ACLs of the audio source device with the primary bud and the secondary bud. It should be understood that in the BLE mode, the primary and secondary buds do not need to be distinguished, and only the left and right buds need to be (or may be) distinguished. For example, when the left and right buds try to establish the BLE connection with the audio source device, they will send their unique identifiers to the audio source device, which are different between the two buds, so that the audio source device can distinguish the left and right buds. The audio source device may transmit audio data of a left channel to the left bud and audio data of a right channel to the right bud.
2. Multi-point topology. At this time, the buds may support connections with multiple audio source devices. When only one audio source device is connected with the buds, please refer to FIGS. 5 and 6 for its connection topology.
a) The LE-ACL (S1<->S1) is established between the open-lid buds, and primary and secondary buds are negotiated by the primary-secondary management module 403.
b) Primary bud: The classic Bluetooth module is set to a discoverable and connectable mode. A BLE module transmits discoverable and connectable advertisement using address P1 as its identifiable address.
c) Secondary bud: The classic Bluetooth module is in an undiscoverable and unconnectable status. A BLE module transmits undiscoverable and connectable advertisement using address S1 as its identifiable address.
d) The first audio source device discovers the buds through scanning to perform connection pairing, establishes the LE-ACL (P0<->P1) and BR/EDR-ACL (P0<->P1) with the primary bud, and establishes the LE-ACL (P0<->S1) with the secondary bud.
d) In the case where there is no role switching, as illustrated in FIG. 7, a second audio source device (having a public address P2) only supporting BLE discovers the buds through scanning to perform connection pairing, establishes a LE-ACL (P2<->P1) with the primary bud, and establishes a LE-ACL (P2<->S1) with the secondary bud.
f) In the case where the role switching occurs, as illustrated in FIG. 8:
i. The left bud (e.g., the original primary bud) is switched to the secondary bud, its classic Bluetooth mode connection information is synchronized to the right bud (e.g., the original secondary bud, the new primary bud). The BLE module stops transmitting the discoverable and connectable advertisement using the address P1 as its identifiable address, and starts to transmit the undiscoverable and connectable advertisement using the address S1 as its identifiable address.
ii. The right bud (e.g., the original secondary bud) is switched to the primary bud, the BLE module stops transmitting the undiscoverable and connectable advertisement using the address S1 as its identifiable address, and starts to transmit the discoverable and connectable advertisement using the address P1 as its identifiable address.
iii) The second audio source device only supporting BLE discovers the buds through scanning to perform connection pairing, establishes a LE-ACL (P2<->P1) with the new primary bud, and establishes a LE-ACL (P2<->S1) with the new secondary bud.

It should be understood that the above-mentioned situation where the second audio source device only supports BLE is taken as an example for illustration. The second audio source device may also only support classic Bluetooth or be compatible with classic Bluetooth and BLE. For the specific manner of establishing the classic Bluetooth connection between the dual-mode TWS buds and the second audio source device, please refer to the manner of establishing the classic Bluetooth connection between the dual-mode TWS buds and the first audio source device, which will not be repeated here.

The specific example may implement an address management method and a network topology method of the dual-mode TWS buds. The example may realize multi-point characteristics of the dual-mode Bluetooth audio device, and be compatible with both of the audio source device that only supports classic Bluetooth and the audio source device that only supports BLE, so as to be able to smooth the user experience during the transition period of Bluetooth audio technology. The specific example may also reduce the connection information synchronized when the roles of the primary and secondary buds are switched, and address the challenge of inconsistent addresses of the classic Bluetooth connection and the BLE connection after the roles of the primary and secondary buds are switched.

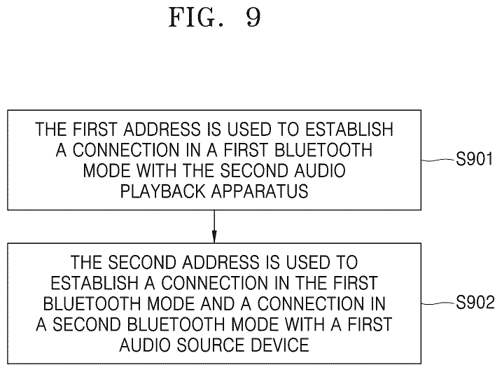

FIG. 9 is a flowchart diagram illustrating a connection method for a first audio playback apparatus as a primary apparatus according to example embodiments of the present inventive concepts. According to example embodiments, an audio playback apparatus group to which the first audio playback apparatus belongs further includes a second audio playback apparatus as a secondary apparatus, wherein the first audio playback apparatus and the second audio playback apparatus each have a first address and a second address. According to example embodiments, each of the first audio playback apparatus and the second audio playback apparatus may share the same first address (or similar first addresses) and the same second address (or similar second addresses).

Referring to FIG. 9, in operation S901, the first address is used to establish a connection in a first Bluetooth mode with the second audio playback apparatus.

the first audio playback apparatus is able to easily transfer information between two audio playback apparatuses by using the first address to establish the connection in the first Bluetooth mode inside the audio playback apparatus group.

In operation S902, the second address is used to establish a connection in the first Bluetooth mode and a connection in a second Bluetooth mode with a first audio source device.

The primary apparatus may realize the connection in two different Bluetooth modes, so that the audio playback apparatus group may support different Bluetooth modes, thereby ensuring the compatibility of the audio playback apparatus group with the audio source devices (or increasing the likelihood thereof). It should be understood that what the present disclosure provides is an ability to establish the connection in different Bluetooth modes with the audio source device. The first audio playback apparatus as the primary apparatus may, or may not, establish the connection in two Bluetooth modes with the first audio source device at the same time (or contemporaneously). Whichever Bluetooth mode the first audio source device supports, the first audio playback apparatus as the primary apparatus in the audio playback apparatus group may establish a connection in the corresponding Bluetooth mode with the first audio source device, and the same to (e.g., a connection in the same or a similar Bluetooth mode may be established by) the second audio playback apparatus as the secondary apparatus.

As an example, the first Bluetooth mode is a BLE mode, and the second Bluetooth mode is a classic Bluetooth mode so as to be compatible with two mainstream Bluetooth modes in the current industry. The second address is a public address capable of supporting establishment of the classic Bluetooth mode connection. The first address is a random address, such as a Static Random Address, a Private Random Address, which may be randomly (or pseudo-randomly) generated after the apparatus starts, to satisfy additional requirements (or standards) in the BLE mode. Specifically, on the one hand, the number of the BLE apparatuses far exceeds the number of classic Bluetooth apparatuses, and application and management of the public addresses are relatively cumbersome, resulting in increased costs for address purchase and maintenance. Random addresses may help to reduce costs; on the other hand, a large part of the application scenarios of the BLE mode is advertising communication, which means that as long as an address of an apparatus is known, all information may be acquired. There are security risks. By using non-fixed random addresses, the risk of information leakage may be reduced and security may be improved. It should be understood that in the present disclosure, the first audio playback apparatus and the second audio playback apparatus each have a first address and a second address, so that they may share a fixed public address and a non-fixed random address, so that there is no need to perform address exchange during role switching. At this time, although the random address may change, the first addresses configured by the first audio playback apparatus and the second audio playback apparatus remain the same (or similar) after each change.

According to example embodiments, the operation S901 includes: setting a connection status in the first Bluetooth mode to a discoverable and connectable status to use the second address to establish the connection in the first Bluetooth mode with the first audio source device; and setting a connection status in the second Bluetooth mode to a discoverable and connectable status to use the second address to establish the connection in the second Bluetooth mode with the first audio source device. Specifically, when the first Bluetooth mode is the BLE mode, the first audio playback apparatus uses the second address to transmit discoverable and connectable advertisement (specifically takes the second address as its identifiable address to transmit the advertisement) so as to establish the connection in the first Bluetooth mode with the first audio source device. By enabling the first audio playback apparatus as the primary apparatus to set the discoverable and connectable status in both Bluetooth modes, the first audio source device may be enabled to discover the primary apparatus and establish the connection in the first Bluetooth mode and the connection in the second Bluetooth mode with it, ensuring the reliable device connection in both Bluetooth modes (or improving the likelihood thereof).

Regarding the second audio playback apparatus as the secondary apparatus, the second audio playback apparatus uses the first address to establish the connection in the first Bluetooth mode with the first audio source device. The secondary apparatus uses the second address that is not used by the primary apparatus to establish the Bluetooth connection with the first audio source device, thereby being able to be distinguished from the primary apparatus. Specifically, the secondary apparatus only establishes the connection in the first Bluetooth mode with the first audio source device without establishing the connection in the second Bluetooth mode, may acquire connection information synchronized by the primary apparatus based on the Bluetooth connection established between the primary and secondary apparatuses, and further implements the acquisition of audio source data by snooping data transmitted between the primary apparatus and the first audio source device under the connection in the second Bluetooth mode. Based on this, when the role switching occurs between the first audio playback apparatus and the second audio playback apparatus, the connection in the first Bluetooth mode between the second audio playback apparatus and the first audio source device may be continuously used without any influence, and the two audio playback apparatuses share the first address and the second address, so that no address exchange and no complex information synchronization in the first Bluetooth mode are required (or implemented) between the two audio playback apparatuses, and the connections between the first audio source device and the two audio playback apparatuses do not need to change either, thereby significantly reducing the difficulty of the software design and implementation.

According to example embodiments, the second audio playback apparatus sets a connection status in the first Bluetooth mode to an undiscoverable and connectable status to use the first address to establish the connection in the first Bluetooth mode with the first audio source device. Specifically, when the first Bluetooth mode is the BLE mode, the second audio playback apparatus uses the first address to transmit undiscoverable and connectable advertisement (specifically takes the first address as an identifiable address of the secondary apparatus to transmit the advertisement) so as to establish the connection in the first Bluetooth mode with the first audio source device. By enabling the second secondary apparatus as the secondary apparatus to only establish the connection in the first Bluetooth mode with the first audio source device without establishing the connection in the second Bluetooth mode with the first audio source device (for example, set the connection status in the second Bluetooth mode to an undiscoverable and unconnectable status), confusion between the two audio playback apparatuses will not be caused from a perspective of the first audio source device, thereby ensuring the reliable establishment of the connection in the second Bluetooth mode (or improving the likelihood thereof). By enabling the secondary apparatus to set the undiscoverable and connectable status in the first Bluetooth mode, for example, to use the first address to transmit the undiscoverable and connectable advertisement, e.g., periodically advertise existence of itself, without responding to scan requests from other apparatuses, the secondary apparatus is enabled to establish the connection in the first Bluetooth mode with the first audio source device which knows the existence of the secondary apparatus (specifically the existence of the secondary apparatus is known through the primary apparatus) without being connected by other audio source devices, so that the primary and secondary apparatuses are enabled to establish the connection in the first Bluetooth mode with the same audio source device (or similar audio source devices), thereby ensuring the reliable establishment of the connection in the first Bluetooth mode (or improving the likelihood thereof).

According to example embodiments, the connection method for the first audio playback apparatus according to an example of the present disclosure further includes: in response to the first audio playback apparatus being switched to the secondary apparatus and the second audio playback apparatus being switched to the primary apparatus, disconnecting the connection in the second Bluetooth mode with the first audio source device, wherein the second audio playback apparatus uses the second address to establish a connection in the second Bluetooth mode with the first audio source device. By transferring the connection in the second Bluetooth mode with the first audio source device from the original primary apparatus (e.g., the first audio playback apparatus) to a new primary apparatus (e.g., the second audio playback apparatus) while the role switching occurs, smooth communication between the new primary apparatus and the first audio source device may be ensured (or improved), and continuous work of the connection in the second Bluetooth mode is maintained. “Disconnect” and “establish” here intend to emphasize the transfer of the connection relationship in the second Bluetooth mode without meaning that it is necessary to perform the operations of disconnecting and establishing the connection. For example, the first audio playback apparatus may synchronize connection information in the second Bluetooth mode with the first audio source device to the second audio playback apparatus, the second audio playback apparatus uses the connection information in the second Bluetooth mode and the second address to perform data transmission with the first audio source device, and at this time, the first audio source device has no sense of role switching and will not perceive the transfer of the connection relationship. Further, when the second Bluetooth mode is the classic Bluetooth mode, before the role switching occurs, in order to realize the snooping of the secondary apparatus, the primary apparatus needs to (or should) synchronize the connection information in the second Bluetooth mode between it and the first audio source device to the second audio playback apparatus. Therefore, if the role switching occurs, the primary apparatus does not need to synchronize (or may not synchronize) the connection information to the secondary apparatus again (except in the case of a change in the connection information, the connection information may be synchronized again at this time to update the changed connection information, not to switch roles), and only informs the secondary apparatus that the secondary apparatus will serve as the new primary apparatus. The connection information in the second Bluetooth mode may represent all the information required (or used) to establish the connection in the second Bluetooth mode. Taking the second Bluetooth mode being the classic Bluetooth mode as an example, the connection information includes, for example, classic Bluetooth connection information (including an access address, a connection key, etc.) and classic Bluetooth Profile information.

According to example embodiments, the connection method for the first audio playback apparatus according to an example of the present disclosure further includes: in response to a presence of a second audio source device, the audio playback apparatus as the primary apparatus among the first audio playback apparatus and the second audio playback apparatus using the second address to establish a connection in the first Bluetooth mode and a connection in the second Bluetooth mode with the second audio source device, and the audio playback apparatus as the secondary apparatus among the first audio playback apparatus and the second audio playback apparatus using the first address to establish a connection in the first Bluetooth mode with the second audio source device. For an audio playback apparatus group that may be connected to multiple audio source devices, regardless of the specific roles of two audio playback apparatuses, as long as during the establishing of Bluetooth connection with the second audio source device, the primary apparatus among the two audio playback apparatuses uses the second address while the secondary apparatus among them uses the first address, the consistency of the connection operations under the roles of the primary apparatus and the secondary apparatus may be guaranteed (or improved), so that the connection relationships of the audio playback apparatus group with the first audio source device and the second audio source device are independent, respectively. The specific connection manner may refer to the above examples, and will not be repeated here. It should be understood that the first audio source device represents the audio source device connected to the audio playback apparatus group earlier, and the second audio source device represents the audio source device connected to the audio playback apparatus group later. They are not fixed references to the audio source devices.

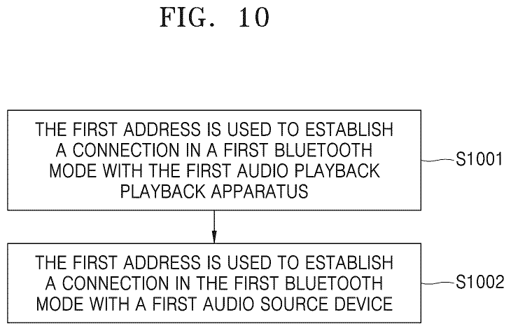

FIG. 10 is a flowchart diagram illustrating a connection method for a second audio playback apparatus as a secondary apparatus according to example embodiments of the present inventive concepts. According to example embodiments, an audio playback apparatus group to which the second audio playback apparatus belongs further includes a first audio playback apparatus as a primary apparatus, wherein the first audio playback apparatus and the second audio playback apparatus each have a first address and a second address. The first audio playback apparatus uses the second address to establish a connection in a first Bluetooth mode and a connection in a second Bluetooth mode with a first audio source device, and may realize connections in two different Bluetooth modes, so that the audio playback apparatus group may support different Bluetooth modes, thereby ensuring the compatibility of the audio playback apparatus group with the audio source devices (or improving the likelihood thereof).

It should be understood that what the present disclosure provides is an ability to establish the connections in different Bluetooth modes with the audio source device. The first audio playback apparatus as the primary apparatus may, or may not, establish connections in two Bluetooth modes with the first audio source device at the same time (or contemporaneously). Whichever Bluetooth mode the first audio source device supports, the first audio playback apparatus as the primary apparatus in the audio playback apparatus group may establish a connection in the corresponding Bluetooth mode with the first audio source device, and the same to (e.g., a connection in the same or a similar Bluetooth mode may be established by) the second audio playback apparatus as the secondary apparatus.

As an example, the first Bluetooth mode is a BLE mode, and the second Bluetooth mode is a classic Bluetooth mode so as to be compatible with two mainstream Bluetooth modes in the current industry. The second address is a public address capable of supporting establishment of the classic Bluetooth mode connection. The first address is a random address, such as a Static Random Address, a Private Random Address, which may be randomly (or pseudo-randomly) generated after the apparatus starts, to satisfy additional requirements (or standards) in the BLE mode. Specifically, on the one hand, the number of the BLE apparatuses far exceeds the number of classic Bluetooth apparatuses, and application and management of the public addresses are relatively cumbersome, resulting in increased costs for address purchase and maintenance. Random addresses may help to reduce costs; on the other hand, a large part of the application scenarios of the BLE mode is advertising communication, which means that as long as an address of an apparatus is known, all information may be acquired. There are security risks. By using non-fixed random addresses, the risk of information leakage may be reduced and security may be improved. It should be understood that in the present disclosure, the first audio playback apparatus and the second audio playback apparatus each have a first address and a second address, so that they may share a fixed public address and a non-fixed random address, so that there is no need to perform address exchange during role switching. At this time, although the random address may change, the first addresses configured by the first audio playback apparatus and the second audio playback apparatus remain the same (or similar) after each change.

According to example embodiments, the first audio playback apparatus sets a connection status in the first Bluetooth mode to a discoverable and connectable status to use the second address to establish the connection in the first Bluetooth mode with the first audio source device; and sets a connection status in the second Bluetooth mode to a discoverable and connectable status to use the second address to establish the connection in the second Bluetooth mode with the first audio source device. Specifically, when the first Bluetooth mode is the BLE mode, the first audio playback apparatus uses the second address to transmit discoverable and connectable advertisement (specifically takes the second address as its identifiable address to transmit the advertisement) so as to establish the connection in the first Bluetooth mode with the first audio source device. By enabling the first audio playback apparatus as the primary apparatus to set the discoverable and connectable status in both Bluetooth modes, the first audio source device may be enabled to discover the primary apparatus and establish the connection in the first Bluetooth mode and the connection in the second Bluetooth mode with it, ensuring the reliable device connection in both Bluetooth modes (or improving the likelihood thereof).

Regarding the connection method for the second audio playback apparatus, referring to FIG. 10, in operation S1001, the first address is used to establish the connection in the first Bluetooth mode with the first audio playback apparatus.

The first and second audio playback apparatuses are able to easily transfer information between two audio playback apparatuses by using the first address to establish the connection in the first Bluetooth mode inside the audio playback apparatus group.

In operation S1002, the first address is used to establish a connection in the first Bluetooth mode with the first audio source device.

The secondary apparatus uses the second address that is not used by the primary apparatus to establish the Bluetooth connection with the first audio source device, thereby being able to be distinguished from the primary apparatus. Specifically, the secondary apparatus only establishes the connection in the first Bluetooth mode with the first audio source device without establishing the connection in the second Bluetooth mode, may acquire connection information synchronized by the primary apparatus based on the Bluetooth connection established between the primary and secondary apparatuses, and further implements the acquisition of audio source data by snooping data transmitted between the primary apparatus and the first audio source device under the connection in the second Bluetooth mode. Based on this, when the role switching occurs between the first audio playback apparatus and the second audio playback apparatus, the connection in the first Bluetooth mode between the second audio playback apparatus and the first audio source device may be continuously used without any influence, and the two audio playback apparatuses share the second address and the first address, so that no address exchange and no complex information synchronization in the first Bluetooth mode are required (or implemented) between the two audio playback apparatuses, and the connections between the first audio source device and the two audio playback apparatuses do not need to change either, thereby significantly reducing the difficulty of the software design and implementation.

According to example embodiments, operation S1002 includes: setting a connection status in the first Bluetooth mode to an undiscoverable and connectable status to use the first address to establish the connection in the first Bluetooth mode with the first audio source device. Specifically, when the first Bluetooth mode is the BLE mode, the first address is used to transmit undiscoverable and connectable advertisement (specifically take the first address as an identifiable address of the secondary apparatus to transmit the advertisement) so as to establish the connection in the first Bluetooth mode with the first audio source device. By enabling the second secondary apparatus as the secondary apparatus to only establish the connection in the first Bluetooth mode with the first audio source device without establishing the connection in the second Bluetooth mode with the first audio source device (for example, set a connection status in the second Bluetooth mode to an undiscoverable and unconnectable status), confusion between the two audio playback apparatuses will not be caused from a perspective of the first audio source device, thereby ensuring the reliable establishment of the connection in the second Bluetooth mode (or improving the likelihood thereof). By enabling the secondary apparatus to set the undiscoverable and connectable status in the first Bluetooth mode, for example, to use the first address to transmit the undiscoverable and connectable advertisement, e.g., periodically advertise existence of itself, without responding to scan requests from other apparatuses, the secondary apparatus is enabled to establish the connection in the first Bluetooth mode with the first audio source device which knows the existence of the secondary apparatus (specifically the existence of the secondary apparatus is known through the primary apparatus) without being connected by other audio source devices, so that the primary and secondary apparatuses are enabled to establish the connection in the first Bluetooth mode with the same audio source device (or similar audio source devices), thereby ensuring the reliable establishment of the connection in the first Bluetooth mode (or improving the likelihood thereof).

According to example embodiments, the connection method for the second audio playback apparatus according to an example of the present disclosure further includes: in response to the first audio playback apparatus being switched to the secondary apparatus and the second audio playback apparatus being switched to the primary apparatus, using the second address to establish a connection in the second Bluetooth mode with the first audio source device, wherein the first audio playback apparatus disconnects the connection in the second Bluetooth mode with the first audio source device. By transferring the connection in the second Bluetooth mode with the first audio source device from the original primary apparatus (e.g., the first audio playback apparatus) to a new primary apparatus (e.g., the second audio playback apparatus) while the role switching occurs, smooth communication between the new primary apparatus and the first audio source device may be ensured (or improved), and continuous work of the connection in the second Bluetooth mode is maintained. “Disconnect” and “establish” here are intended to emphasize the transfer of the connection relationship in the second Bluetooth mode without meaning that it is necessary to perform the operations of disconnecting and establishing the connection. For example, the second audio playback apparatus may receive connection information in the second Bluetooth mode between the first audio playback apparatus and the first audio source device synchronized by the first audio playback apparatus, and uses the connection information in the second Bluetooth mode and the second address to perform data transmission with the first audio source device, and at this time, the first audio source device has no sense of role switching and will not perceive the transfer of the connection relationship. Further, when the second Bluetooth mode is the classic Bluetooth mode, before the role switching occurs, in order to realize the snooping of the secondary apparatus, the secondary apparatus receives the connection information in the second Bluetooth mode between the primary apparatus and the first audio source device synchronized by the primary apparatus. Therefore, if the role switching occurs, the connection information does not need to be synchronized (or may not be synchronized) again (except in the case of a change in the connection information, the connection information may be synchronized again at this time to update the changed connection information, not to switch roles), and the primary apparatus only informs the secondary apparatus that the secondary apparatus will serve as the new primary apparatus. The connection information in the second Bluetooth mode may represent all the information required (or used) to establish the connection in the second Bluetooth mode. Taking the second Bluetooth mode being the classic Bluetooth mode as an example, the connection information includes, for example, classic Bluetooth connection information (including an access address, a connection key, etc.) and classic Bluetooth Profile information.

According to example embodiments, the connection method for the second audio playback apparatus according to an example of the present disclosure further includes: in response to a presence of a second audio source device, the audio playback apparatus as the primary apparatus among the first audio playback apparatus and the second audio playback apparatus using the second address to establish a connection in the first Bluetooth mode and a connection in the second Bluetooth mode with the second audio source device, and the audio playback apparatus as the secondary apparatus among the first audio playback apparatus and the second audio playback apparatus using the first address to establish a connection in the first Bluetooth mode with the second audio source device. For an audio playback apparatus group that may be connected to multiple audio source devices, regardless of the specific roles of two audio playback apparatuses, as long as during the establishing of Bluetooth connection with the second audio source device, the primary apparatus among the two audio playback apparatuses uses the second address while the secondary apparatus among them uses the first address, the consistency of the connection operations under the roles of the primary apparatus and the secondary apparatus may be guaranteed (or improved), so that the connection relationships of the audio playback apparatus group with the first audio source device and the second audio source device are independent, respectively. The specific connection manner may refer to the above examples, and will not be repeated here. It should be understood that the first audio source device represents the audio source device connected to the audio playback apparatus group earlier, and the second audio source device represents the audio source device connected to the audio playback apparatus group later. They are not fixed references to the audio source devices.

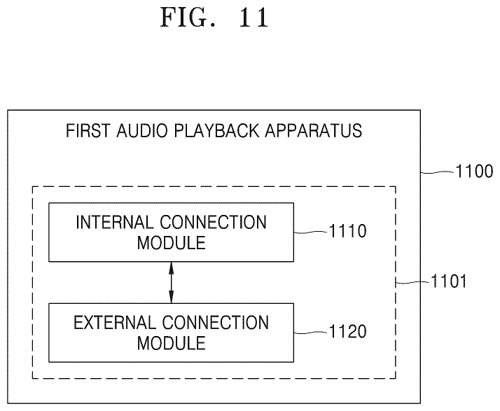

FIG. 11 is a block diagram illustrating a first audio playback apparatus as a primary apparatus according to example embodiments of the present inventive concepts. According to example embodiments, an audio playback apparatus group to which the first audio playback apparatus belongs further includes a second audio playback apparatus as a secondary apparatus, wherein the first audio playback apparatus and the second audio playback apparatus each have a first address and a second address.

Referring to FIG. 11, a first audio playback apparatus 1100 according to example embodiments of the present inventive concepts may include a processing circuit 1101, which may include an internal connection module 1110 and/or an external connection module 1120, and the like, but example embodiments are not limited hereto, and the first audio playback apparatus 1100 may include a larger or smaller number of components, such as a memory, an audio processor, etc. According to example embodiments, the processing circuit 1101 including the internal connection module 1110 and/or the external connection module 1120, and the like, may include: hardware or hardware circuitry having logic circuitry; a hardware/software combination, such as a processor executing software and/or firmware; or a combination thereof. For example, more specifically, the processing circuit 1101 may specifically include, but is not limited to, a central processing unit (CPU), an arithmetic logic unit (ALU), a digital signal processor, a microcomputer, a field programmable gate array (FPGA), a system on a chip (SoC), a programmable logic unit, a microprocessor, an application specific integrated circuit (ASIC), etc.

The internal connection module 1110 may be configured to use the first address to establish connection in a first Bluetooth mode with the second audio playback apparatus.

The external connection module 1120 may be configured to use the second address to establish a connection in the first Bluetooth mode and connection in a second Bluetooth mode with the first audio source device. Wherein, the second audio playback apparatus uses the first address to establish a connection in the first Bluetooth mode with the first audio source device.

The external connection module 1120 may be further configured to set a connection status in the first Bluetooth mode to a discoverable and connectable status to use the second address to establish the connection in the first Bluetooth mode with the first audio source device, and set a connection status in the second Bluetooth mode to the discoverable and connectable status to use the second address to establish the connection in the second Bluetooth mode with the first audio source device.

The external connection module 1120 may be further configured to, in response to the first audio playback apparatus being switched to the secondary apparatus and the second audio playback apparatus being switched to the primary apparatus, disconnect the connection in the second Bluetooth mode with the first audio source device, wherein the second audio playback apparatus uses the second address to establish a connection in the second Bluetooth mode with the first audio source device.

The external connection module 1120 may be further configured to, in response to a presence of a second audio source device, make the audio playback apparatus as the primary apparatus among the first audio playback apparatus and the second audio playback apparatus use the second address to establish a connection in the second Bluetooth mode and a connection in the first Bluetooth mode with the second audio source device, and the audio playback apparatus as the secondary apparatus among the first audio playback apparatus and the second audio playback apparatus use the first address to establish a connection in the first Bluetooth mode with the second audio source device.

According to example embodiments, the first Bluetooth mode includes a BLE mode, and the second Bluetooth mode includes a classic Bluetooth mode; and the first address includes a static random address, and the second address includes a public address.

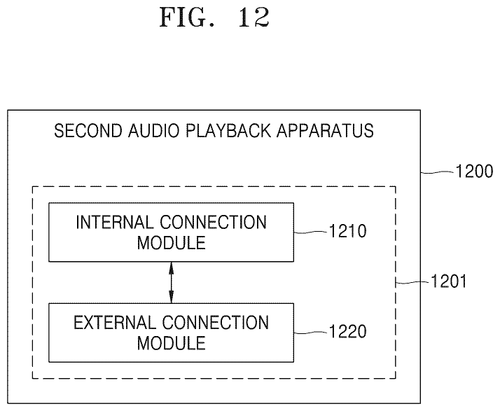

FIG. 12 is a block diagram illustrating a second audio playback apparatus as a secondary apparatus according to example embodiments of the present inventive concepts. According to example embodiments, an audio playback apparatus group to which the second audio playback apparatus belongs further includes a first audio playback apparatus as a primary apparatus, wherein the first audio playback apparatus and the second audio playback apparatus each have a first address and a second address.

Referring to FIG. 12, a second audio playback apparatus 1200 according to example embodiments of the present inventive concepts may include a processing circuit 1201, which may include an internal connection module 1210 and/or an external connection module 1220, and the like, but example embodiments are not limited hereto, and the second audio playback apparatus 1200 may include a larger or smaller number of components, such as a memory, an audio processor, etc. According to example embodiments, the processing circuit 1201 including the internal connection module 1210 and/or the external connection module 1220, and the like, may include: hardware or hardware circuitry having logic circuitry; a hardware/software combination, such as a processor executing software and/or firmware; or a combination thereof. For example, more specifically, the processing circuit 1201 may specifically include, but is not limited to, a central processing unit (CPU), an arithmetic logic unit (ALU), a digital signal processor, a microcomputer, a field programmable gate array (FPGA), a system on a chip (SoC), a programmable logic unit, a microprocessor, an application specific integrated circuit (ASIC), etc.

The internal connection module 1210 may be configured to use the first address to establish connection in a first Bluetooth mode with the first audio playback apparatus.

The external connection module 1220 may be configured to use the first address to establish a connection in the first Bluetooth mode with the first audio playback apparatus. Wherein, the first audio playback apparatus uses the second address to establish a connection in the first Bluetooth mode and connection in a second Bluetooth mode with the first audio source device.

The external connection module 1220 may be further configured to set a connection status in the first Bluetooth mode to an undiscoverable and connectable status to use the first address to establish the connection in the first Bluetooth mode with the first audio source device.

The external connection module 1220 may be further configured to, in response to the first audio playback apparatus being switched to the secondary apparatus and the second audio playback apparatus being switched to the primary apparatus, use the second address to establish a connection in the second Bluetooth mode with the first audio source device, wherein the first audio playback apparatus disconnects the connection in the second Bluetooth mode with the first audio source device.

The external connection module 1220 may be further configured to, in response to a presence of a second audio source device, make the audio playback apparatus as the primary apparatus among the first audio playback apparatus and the second audio playback apparatus use the second address to establish a connection in the second Bluetooth mode and a connection in the first Bluetooth mode with the second audio source device, and the audio playback apparatus as the secondary apparatus among the first audio playback apparatus and the second audio playback apparatus use the first address to establish a connection in the first Bluetooth mode with the second audio source device.

According to example embodiments, the first Bluetooth mode includes a BLE mode, and the second Bluetooth mode includes a classic Bluetooth mode; and the first address includes a static random address, and the second address includes a public address.

According to example embodiments of the present inventive concepts, there is provided an audio playback apparatus group, including the above-described first audio playback apparatus and/or second audio playback apparatus, but example embodiments are not limited hereto.

According to example embodiments of the present inventive concepts, there is provided a non-transitory computer-readable medium having stored thereon computer executable instructions that, when executed by a processing circuit (e.g., the processing circuit 1101 and/or the processing circuit 1201), cause the processing circuit to execute at least one of the aforementioned methods. Examples of the non-transitory computer-readable medium here may include: Read Only Memory (ROM), Random Access Programmable Read Only Memory (PROM), Electrically Erasable Programmable Read Only Memory (EEPROM), Random Access Memory (RAM), Dynamic Random Access Memory (DRAM), Static Random Access Memory (SRAM), Flash, Non-Volatile Memory, CD-ROM, CD-R, CD+R, CD-RW, CD+RW, DVD-ROM, DVD-R, DVD+R, DVD-RW, DVD+RW, DVD-RAM, BD-ROM, BD-R, BD-R LTH, BD-RE, Blu-ray and/or optical disc storage, hard disk drive (HDD), solid state drive (SSD), card storage (such as, Multimedia Cards, Secure Digital (SD) Cards or Extreme Digital (XD) Cards, etc.), magnetic tapes, floppy disks, magneto-optical data storage devices, optical data storage devices, and any other device. The any other device is configured to store a computer program, a computer readable and/or executable instructions and/or any relevant data, data files and data structures in a non-transitory manner and to provide the computer program and any relevant data, data files and data structures to a processor or computer, so that the processor and/or computer may execute the computer program and so on. The computer program in the above non-transitory computer-readable medium may run and/or be executed in an environment deployed in computer devices such as a client, a host, an agent device and a server. In addition, in an example, the computer program and any relevant data, data files and data structures are distributed over networked computer systems, so that the computer program and any relevant data, data files and data structures are stored, accessed and executed in a distributed manner by one or more processors and/or computers and the like.

According to example embodiments of the present inventive concepts, there is provided a non-transitory computer program product including computer executable instructions that, when executed by a processing circuit (e.g., the processing circuit 1101 and/or the processing circuit 1201), cause the processing circuit to execute at least one of the aforementioned methods, but example embodiments are not limited hereto.

According to example embodiments of the present inventive concepts, by configuring a first address and a second address to a first audio playback apparatus and a second audio playback apparatus of an audio playback apparatus group at the same time (e.g., contemporaneously), on the one hand, it is possible to make the two audio playback apparatuses use different addresses to establish the Bluetooth connections with the first audio source device, that is, the first audio playback apparatus uses the second address and the second audio playback apparatus uses the first address, so that reliable establishment of the Bluetooth connection may be ensured (or improved). On the other hand, the operations related to primary-secondary role switching between the two audio playback apparatuses can be simplified. Namely, from the perspective of information synchronization, since both audio playback apparatuses have established a connection in the first Bluetooth mode with the first audio source device respectively, after the role switching, the original connections in the first Bluetooth mode may be continuously used without being affected, so that the two audio playback apparatuses only need to (or should) synchronize the connection information related to the second Bluetooth mode, without needing to synchronize the connection information related to the first Bluetooth mode (or decreasing the likelihood thereof), which can simplify information synchronization and reduce related computational complexity. From the perspective of address exchange, since both audio playback apparatuses share the same first address, when transferring the connection in the second Bluetooth mode with the first audio source device from the first audio playback apparatus to the second audio playback apparatus, the second audio playback apparatus can directly use its own first address without performing address exchange operation. Therefore, when primary-secondary role switching occurs between the two audio playback apparatuses, no address exchange, complex information synchronization, and corresponding configuration is required (or implemented). Besides, from the perspective of the first audio source device, its connection information with the first audio playback apparatus in the first Bluetooth mode has been synchronized to the second audio playback apparatus, while the connection itself in the first Bluetooth mode has not changed, and its connections with the two audio playback apparatuses in the second Bluetooth mode have not changed either. Therefore, the connection between the first audio source device and the audio playback apparatus group may be unchanged, thereby significantly reducing the difficulty of the software design and implementation. In addition, since both of the audio playback apparatuses establish the connection in the first Bluetooth mode with the first audio source device, tolerance of the audio playback apparatus group to connection congestion or abnormality may be improved, and robustness of the audio playback apparatus group is improved.

Conventional devices and methods for supporting dual-mode audio assign a different public address to each of two different ear buds. Accordingly, in scenarios in which a primary bud is switched to a secondary bud (and vice versa), the public addresses of the different ear buds are swapped resulting in complex synchronization between the different ear buds. Such a scenario may occur, for example, based on a primary bud having a battery voltage that falls below a threshold or based on a detection that the primary bud is not in-ear (e.g., not within a user's ear). Such complex synchronization results in excessive resource consumption (e.g., power, processor, etc.) as well as excessive complexity and manufacturing cost of the ear buds.

However, according to example embodiments, improved devices and methods are provided for supporting dual-mode audio. For example, the improved devices and methods may share a first and second address between two different ear buds. Accordingly, in scenarios in which a primary bud is switched to a secondary bud (and vice versa), the addresses of the different ear buds are not swapped and the complexity of the synchronization is reduced. Therefore, the improved devices and methods overcome the deficiencies of the conventional devices and methods to at least reduce resource consumption (e.g., power, processor, etc.), the complexity of the ear buds and/or manufacturing cost of the ear buds.

According to example embodiments, operations described herein as being performed by either or both of the dual-mode TWS buds, the dual-mode connection module 401, the address management module 402, the primary-secondary management module 403, the topology management module 404, the classic Bluetooth module, the BLE module, the first audio playback apparatus 1100, the processing circuit 1101, the internal connection module 1110, the external connection module 1120, the second audio playback apparatus 1200, the processing circuit 1201, the internal connection module 1210 and/or the external connection module 1220 may be performed by processing circuitry. The term ‘processing circuitry,’ as used in the present disclosure, may refer to, for example, hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

The various operations of methods described above may be performed by any suitable device capable of performing the operations, such as the processing circuitry discussed above. For example, as discussed above, the operations of methods described above may be performed by various hardware and/or software implemented in some form of hardware (e.g., processor, ASIC, etc.).

The software may comprise an ordered listing of executable instructions for implementing logical functions, and may be embodied in any “processor-readable medium” for use by or in connection with an instruction execution system, apparatus, or device, such as a single or multiple-core processor or processor-containing system.

The blocks or operations of a method or algorithm, and/or functions, described in connection with example embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art.

Although example embodiments of the present inventive concepts have been illustrated and described with reference to specific examples, it will be understood by those ordinarily skilled in the art that various changes in form and detail may be made without departing from the spirit and scope of example embodiments of the present inventive concepts as defined by the claims and the equivalents thereof.

1. A connection method for an audio playback apparatus group, the audio playback apparatus group including a first audio playback apparatus and a second audio playback apparatus, the first audio playback apparatus and the second audio playback apparatus each sharing a first address and a second address, and the connection method comprising:
establishing a first connection between the first audio playback apparatus and the second audio playback apparatus using the first address, the first connection being based on a first Bluetooth mode;
establishing, by the first audio playback apparatus, a second connection and a third connection with a first audio source device using the second address, the second connection being based on the first Bluetooth mode, and the third connection being based on a second Bluetooth mode; and
establishing, by the second audio playback apparatus, a fourth connection with the first audio source device using the first address, the fourth connection being based on first Bluetooth mode.

2. The connection method of claim 1, wherein the establishing the second connection and the third connection comprises:
setting, by the first audio playback apparatus, a connection status in the first Bluetooth mode to a discoverable and connectable status; and
setting, by the first audio playback apparatus, a connection status in the second Bluetooth mode to a discoverable and connectable status.

3. The connection method of claim 1, wherein the establishing the fourth connection comprises:
setting, by the second audio playback apparatus, a connection status in the first Bluetooth mode to an undiscoverable and connectable status.

4. The connection method of claim 1, wherein the connection method further comprises:
disconnecting, by the first audio playback apparatus, the third connection in response to the first audio playback apparatus being switched from a primary apparatus to a secondary apparatus; and
establishing, by the second audio playback apparatus, a fifth connection with the first audio source device using the second address in response to the second audio playback apparatus being switched from the secondary apparatus to the primary apparatus, and the fifth connection being based on the second Bluetooth mode.

5. The connection method of claim 1, wherein the connection method further comprises:
establishing, by a primary apparatus, a sixth connection and a seventh connection with a second audio source device using the second address in response to determining a presence of the second audio source device, the primary apparatus being a first apparatus among the first audio playback apparatus and the second audio playback apparatus, the sixth connection being based on the first Bluetooth mode, and the seventh connection being based on the second Bluetooth mode; and
establishing, by a secondary apparatus, an eighth connection with the second audio source device using the first address in response to determining the presence of the second audio source device, the secondary apparatus being a second apparatus among the first audio playback apparatus and the second audio playback apparatus, the second apparatus being different from the first apparatus, and the eighth connection being based on the first Bluetooth mode.

6. The connection method of claim 1, wherein
the first Bluetooth mode is a BLE mode, and the second Bluetooth mode is a classic Bluetooth mode; or
the first address is a static random address, and the second address is a public address.

7. A connection method for a first audio playback apparatus in an audio playback apparatus group, the audio playback apparatus group including a second audio playback apparatus, the first audio playback apparatus and the second audio playback apparatus each sharing a first address and a second address, and the connection method comprising:
establishing a first connection with the second audio playback apparatus using the first address, the first connection being based on a first Bluetooth mode; and
establishing a second connection and a third connection with a first audio source device using the second address, the second connection being based on the first Bluetooth mode, the third connection being based on a second Bluetooth mode, and a fourth connection being established between the second audio playback apparatus and the first audio source device using the first address, the fourth connection being based on the first Bluetooth mode.

8. The connection method of claim 7, wherein the establishing the second connection and the third connection comprises:
setting a connection status in the first Bluetooth mode to a discoverable and connectable status; and
setting a connection status in the second Bluetooth mode to a discoverable and connectable status.

9. The connection method of claim 7, wherein the connection method further comprises:
disconnecting the third connection in response to the first audio playback apparatus being switched from a primary apparatus to a secondary apparatus, a fifth connection being established between the second audio playback apparatus and the first audio source device using the second address in response to the second audio playback apparatus being switched from the secondary apparatus to the primary apparatus, and the fifth connection being based on the second Bluetooth mode.

10. The connection method of claim 7, wherein the connection method further comprises:
establishing a sixth connection and a seventh connection with a second audio source device using the second address in response to determining a presence of the second audio source device and based on the first audio playback apparatus being a primary apparatus, the sixth connection being based on the first Bluetooth mode, and the seventh connection being based on the second Bluetooth mode; or
establishing an eighth connection with the second audio source device using the first address in response to determining the presence of the second audio source device and based on the first audio playback apparatus being a secondary apparatus, the eighth connection being based on the first Bluetooth mode.

11. The connection method of claim 7, wherein
the first Bluetooth mode is a BLE mode, and the second Bluetooth mode is a classic Bluetooth mode; or
the first address is a static random address, and the second address is a public address.

12. A connection method for a second audio playback apparatus in an audio playback apparatus group, the audio playback apparatus group including a first audio playback apparatus, the first audio playback apparatus and the second audio playback apparatus each sharing a first address and a second address, and the connection method comprising:
establishing a first connection with the first audio playback apparatus using the first address, the first connection being based on a first Bluetooth mode; and
establishing a second connection with a first audio source device using the first address, the second connection being based on the first Bluetooth mode, a third connection and a fourth connection being established between the first audio playback apparatus and the first audio source device using the second address, the third connection being based on the first Bluetooth mode, and the fourth connection being based on a second Bluetooth mode.

13. The connection method of claim 12, wherein the establishing the second connection comprises:
setting a connection status in the first Bluetooth mode to an undiscoverable and connectable status.

14. The connection method of claim 12, wherein the connection method further comprises:
establishing a fifth connection with the first audio source device using the second address in response to the second audio playback apparatus being switched to a primary apparatus from a secondary apparatus, the fifth connection being based on the second Bluetooth mode, the fourth connection being disconnected based on the first audio playback apparatus being switched to the secondary apparatus from the primary apparatus.

15. The connection method of claim 12, wherein the connection method further comprises:
establishing a sixth connection and a seventh connection with a second audio source device using the second address in response to determining a presence of the second audio source device and based on the second audio playback apparatus being a primary apparatus, the sixth connection being based on the first Bluetooth mode, and the seventh connection being based on the second Bluetooth mode; or
establishing an eighth connection with the second audio source device using the first address in response to determining the presence of the second audio source device and based on the second audio playback apparatus being a secondary apparatus, the eighth connection being based on the first Bluetooth mode.

16. The connection method of claim 12, wherein:
the first Bluetooth mode is a BLE mode, and the second Bluetooth mode is a classic Bluetooth mode; or
the first address is a static random address, and the second address is a public address.

17.-29. (canceled)
